(19) United States
(12) Patent Application Publication
(10) Pub. No.: US 2024/0078435 A1
(43) Pub. Date: Mar. 7, 2024

(54) SYSTEMS AND METHODS FOR UNIT TEST GENERATION USING REINFORCEMENT LEARNING AUGMENTED TRANSFORMER ARCHITECTURES

(71) Applicant: JPMORGAN CHASE BANK, N.A., New York, NY (US)

(72) Inventors: Rohan SAPHAL, Glasgow (GB); Georgios PAPADOPOULOS, London (GB); Fanny SILAVONG, London (GB); Sean MORAN, London (GB)

(21) Appl. No.: 18/450,877

(22) Filed: Aug. 16, 2023

(30) Foreign Application Priority Data
Sep. 5, 2022 (GR) 20220100726

(51) Int. Cl. G06N 3/092; G06N 3/0455

(52) U.S. Cl. CPC G06N 3/092; G06N 3/0455

(57) ABSTRACT

Systems and methods for unit test generation using reinforcement learning augmented transformer architectures are disclosed. A method may include: receiving raw data for source code from a database; identifying a function for which a unit test will be generated and an existing unit test for that function; receiving the function and the existing unit test; generating a generated unit test for the function using the function for the unit test and the existing unit test using a deep learning model; applying a loss function to the generated unit test, wherein the loss function is based on a comparison between the generated unit test and the existing unit test and results of the application of the loss function are fed back to the transformer computer program; simulating the generated unit test using a simulator; generating scalar feedback; and refining the generated unit test using the scalar feedback.

### RELATED APPLICATIONS

This application claims priority to Greek Patent Application No. 20220100726, filed Sep. 5, 2022, the disclosure of which is hereby incorporated, by reference, in its entirety.

### BACKGROUND OF THE INVENTION

### 1. Field of the Invention

Embodiments relate generally to systems and methods for unit test generation using reinforcement learning augmented transformer architectures.

### 2. Description of the Related Art

Technical organizations with large codebases face the problem of high maintenance costs and risks associated with poorly tested source code put into production. Unit tests help to improve the overall quality of the software developed through identification of bugs and controlled integration of new code. Despite this, developers often underestimate the importance of unit tests and potentially fail to create them. The resulting cost and time associated with fixing bugs at a later stage of the development cycle can be exponentially higher.

### SUMMARY OF THE INVENTION

Systems and methods for unit test generation using reinforcement learning augmented transformer architectures are disclosed. According to an embodiment, a method may include: (1) receiving, by a code and unit test quality filter computer program, raw data for source code from a database; (2) identifying, by the code and unit test quality filter computer program, a function for which a unit test will be generated and an existing unit test for that function; (3) receiving, by a transformer computer program, the function and the existing unit test; (4) generating, by the transformer computer program, a generated unit test for the function using the function for the unit test and the existing unit test using a deep learning model; (5) applying, by the transformer computer program, a loss function to the generated unit test, wherein the loss function may be based on a comparison between the generated unit test and the existing unit test and results of the application of the loss function are fed back to the transformer computer program; (6) simulating, by a simulator computer program, the generated unit test using a simulator; (7) generating, by a simulator computer program, scalar feedback; and (8) refining, by the transformer computer program, the generated unit test using the scalar feedback.

In one embodiment, the transformer computer program further receives an abstract syntax tree or a docstring for the source code.

In one embodiment, the method may also include: generating, by the code and unit test quality filter computer program, an auxiliary loss function; and retraining, by the code and unit test quality filter computer program, the deep learning model using the loss function and the auxiliary loss function.

In one embodiment, the unit test may be generated using token-by-token generation and/or character-by-character generation.

In one embodiment, the method may also include repeating the steps of generating the loss function, simulating the generated unit test, generating scalar feedback, and refining the generated unit test until a data-driven threshold is met.

In one embodiment, the data-driven threshold may be based on the loss function.

According to another embodiment, a method for reinforcement learning training may include: (1) loading, by a transformer computer program, model parameters; (2) generating, by the transformer computer program, a generated unit test using the model parameters; (3) determining, by a simulator, that the generated unit test compiles; (4) generating, by the simulator, scalar feedback by simulating the generated unit test; and (5) refining, by the transformer computer program, the generated unit test based on the scalar feedback.

In one embodiment, the scalar feedback may be generated using a net scalar reward function.

In one embodiment, the scalar feedback may be based on quality metrics and/or performance metrics.

In one embodiment, the transformer computer program refines the generated unit test to maximize the net scalar reward function.

According to another embodiment, a non-transitory computer readable storage medium may include instructions stored thereon, which when read and executed by one or more computer processors, cause the one or more computer processors to perform steps comprising: receiving raw data for source code from a database; identifying a function for which a unit test will be generated and an existing unit test for that function; receiving the function and the existing unit test; generating a generated unit test for the function using the function for the unit test and the existing unit test using a deep learning model; applying a loss function to the generated unit test, wherein the loss function may be based on a comparison between the generated unit test and the existing unit test; simulating the generated unit test using a simulator; generating scalar feedback; and refining the generated unit test using the scalar feedback.

In one embodiment, the non-transitory computer readable storage medium may also include instructions stored thereon, which when read and executed by one or more computer processors, cause the one or more computer processors to receive an abstract syntax tree or a docstring for the source code.

In one embodiment, the non-transitory computer readable storage medium may also include instructions stored thereon, which when read and executed by one or more computer processors, cause the one or more computer processors to perform steps comprising: generating an auxiliary loss function; and retraining the deep learning model using the loss function and the auxiliary loss function.

In one embodiment, the unit test may be generated using token-by-token generation and/or character-by-character generation.

In one embodiment, the non-transitory computer readable storage medium may also include instructions stored thereon, which when read and executed by one or more computer processors, cause the one or more computer processors to repeat the steps of generating the loss function, simulating the generated unit test, generating scalar feedback, and refining the generated unit test until a data-driven threshold is met.

In one embodiment, the data-driven threshold may be based on the loss function.

According to one embodiment, a method for unit test generation using reinforcement learning augmented transformer architectures may include: receiving, by a code and unit test quality filter computer program, raw data from a database; identifying, by the code and unit test quality filter computer program, a function for which a unit test will be generated and a unit test for that function that has been written; receiving, by a transformer computer program, the function for the unit test and an existing unit test or sample unit tests; generating, by the transformer computer program, a generated unit test for the function using the function for the unit test and an existing unit test or sample unit tests; generating, by the transformer computer program, a loss function by comparing the generated unit test to the unit test identified by the code and unit test quality filter; simulating, by a simulator computer program, the generated unit test using a simulator; generating scalar feedback; and refining, by the transformer computer program, the generated unit test using the scalar feedback.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for filtering code and a unit test from raw data according to an embodiment; and

FIG. 2 depicts a system for unit test generation using reinforcement learning augmented transformer architectures according to an embodiment;

FIG. 3 depicts a system for unit test refinement using reinforcement learning according to an embodiment;]

FIG. 4 depicts a method for deep learning training according to an embodiment;

FIG. 5 depicts a method for reinforcement learning training according to an embodiment;

FIG. 6 depicts a method for generation of unit tests during inference according to an embodiment; and

FIG. 7 depicts an exemplary computing system for implementing aspects of the present disclosure.

### DETAILED DESCRIPTION OF PREFERRED EMBODIMENTS

Embodiments relate generally to systems and methods for unit test generation using reinforcement learning augmented transformer architectures.

Embodiments may auto generate unit tests using machine learning (e.g., transformer architectures) and may augment the transformer architectures with reinforcement learning. An exemplary approach may include test generation and test refinement. Test generation may involve generating unit tests using a deep learning architecture framework, such as a transformer, using existing unit tests written by developers. Test refinement may refine and improve the generated unit tests in order to increase accuracy and probability of satisfying certain criteria in terms of quality and coverage using, for example, reinforcement learning.

Embodiments may include a machine learning component that leverages existing unit tests written by developers and align the generated unit tests to existing pattern of unit tests.

In embodiments, the framework may be language agnostic unlike existing tools and can be used for generating unit tests across any programming language.

Embodiments may generate unit tests from scratch as well as augmenting existing unit tests to make them more accurate.

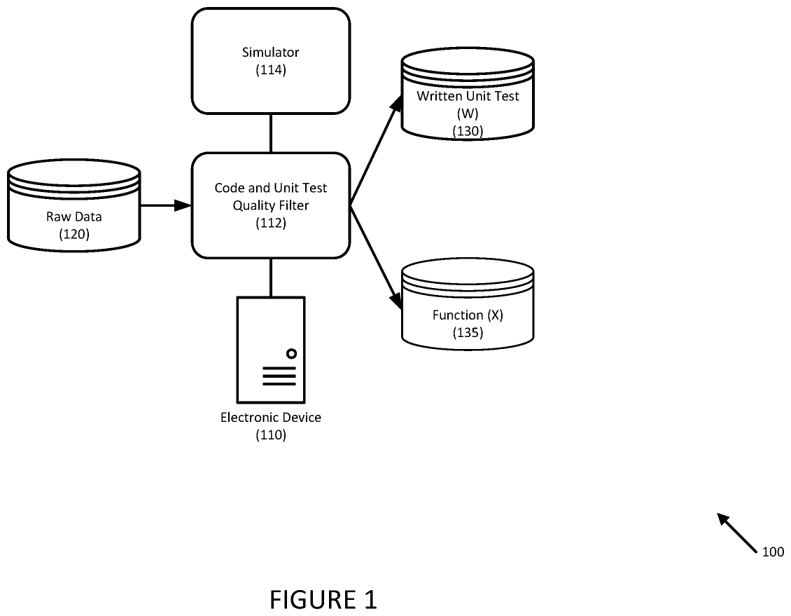

Referring to FIG. 1, a system for filtering code and a unit test from raw data is disclosed according to an embodiment. System 100 may include electronic device 110 that may execute code and unit test quality filter computer program 112. Electronic device 110 may be any suitable electronic device, including servers (e.g., physical and/or cloud based), workstations, computers (e.g., desktop, notebook, tablet, etc.).

Code and unit test quality filter computer program 112 may receive raw data 120 from a database and may filter the raw data to output written unit test (W) 130 and function (X) 135 for which a unit test will be generated. Code and unit test quality filter computer program 112 may parse the source code to separate the unit test and function being tested. It may also run through the quality filter to remove poor quality unit tests at any point.

Simulator 114 may be a computer program executed by electronic device 110 that, given a generated unit test, determines the compilation success of a unit test, and outputs a scalar score.

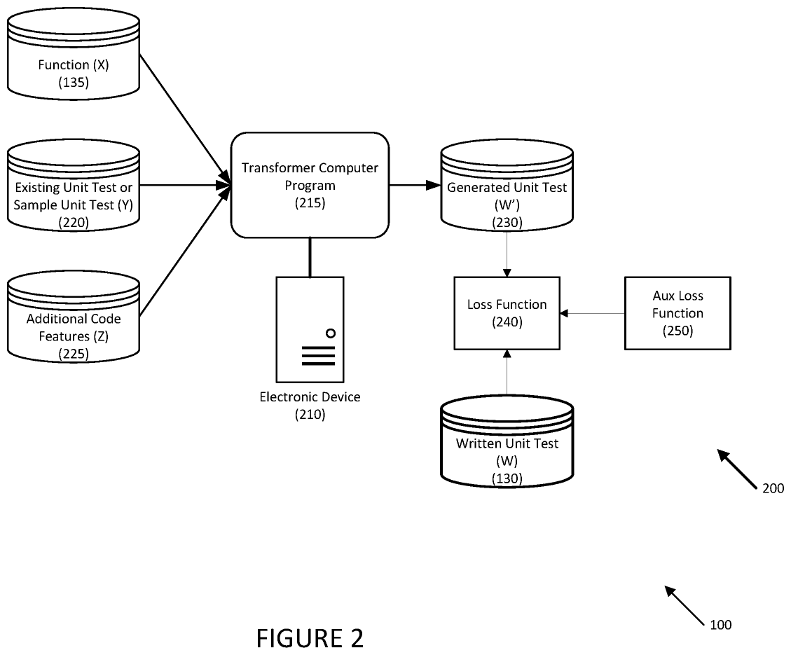

Referring to FIG. 2, a system for unit test generation using reinforcement learning augmented transformer architectures is disclosed according to an embodiment. System 200 may include electronic device 210 that may execute transformer computer program 215. Like electronic device 110, electronic device 210 may be any suitable electronic device, including servers (e.g., physical and/or cloud based), workstations, computers (e.g., desktop, notebook, tablet, etc.).

Transformer computer program 215 may receive function (X) 135, existing unit test or sample unit test (Y) 220, such as an auto-generated unit test or human attempt of unit test (complete or incomplete), and optionally additional code features (Z) 225 (e.g., an abstract syntax tree (AST), a docstring, etc.) from one or more database. Y may be considered to be a guide to model generation.

It may then generate generated unit test (W′). Loss function 240 may be generated from generated unit test (W′) 230 and written unit test (W) 130 by comparing the two tests. Auxiliary loss function 250 may be provided to loss function 240. Auxiliary loss function 250 may be derived from quality and performance metrics.

W may be considered to be the ground-truth—the expected ideal output of the generated unit test. At inference time, the model may take the existing attempts if exists into consideration for the final generation.

In one embodiment, generated unit test (W′) may follow a similar pattern as existing unit test or sample unit test (Y) 220. W′ may be generated by the deep learning model, such as the transformer based on X, Y and Z, and W.

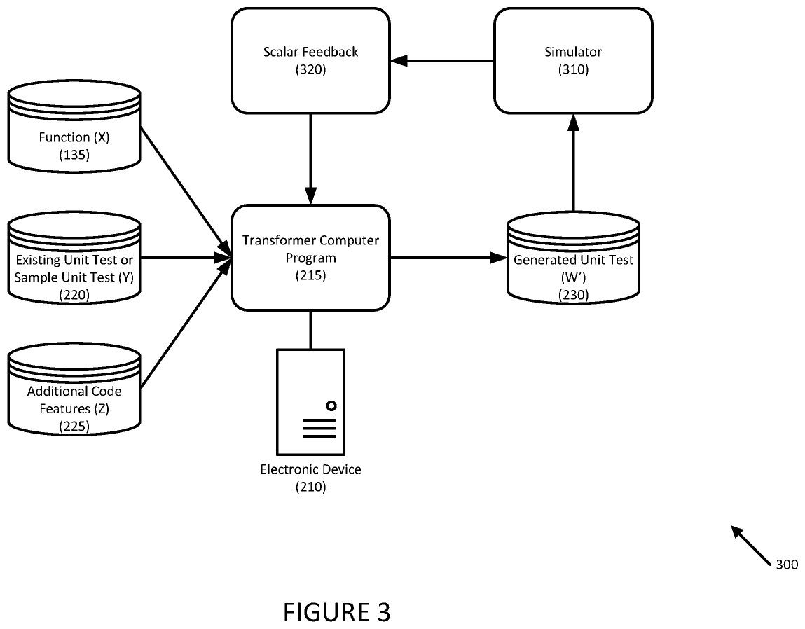

Referring to FIG. 3, a system for unit test refinement using reinforcement learning is disclosed according to an embodiment. It should be noted that system 200 and system 300 may be the same system. System 300 may include simulator 310 that may simulate the execution of generated unit test (W′) 230 and may determine whether generated unit test (W′) 230 will compile. It may then output scalar feedback 320 to transformer computer program 215, which may use scalar feedback 320 to refine generated unit test (W′) 230.

In one embodiment, scalar feedback 320 may include auxiliary metrics such as those related to quality and performance. Scalar feedback 320 may be a value based on the following:

$$R = r - βlog ( \frac{{T}_{i}}{{T}_{0}} ) + Q + P$$

where: R is a Net Scalar Reward Function;
r is a reward function at a time-step;
T is a model state at time T;
β is a scaling factor;
Q is a quality metric;
P is a performance metric;

$$r - βlog ( \frac{{T}_{i}}{{T}_{0}} )$$

is a model success metric; and
Q+P is a quality and performance metric.

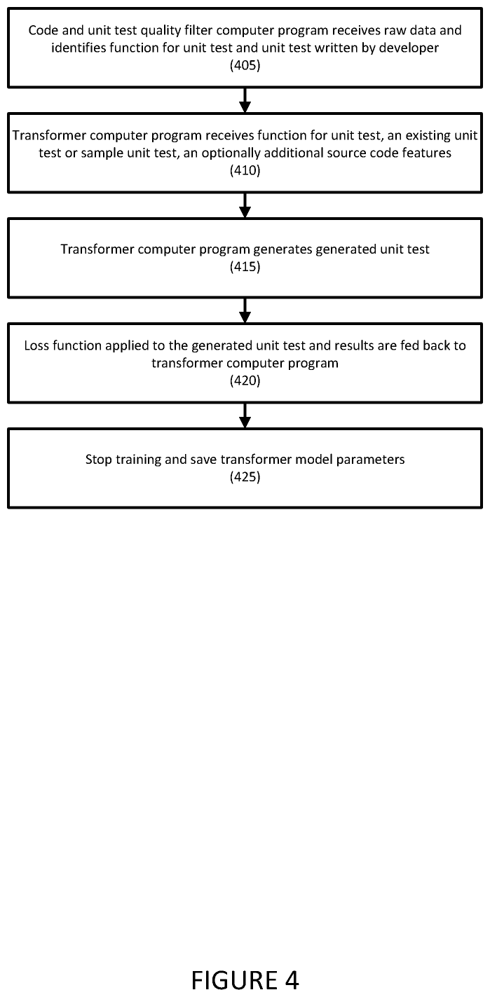

Referring to FIG. 4, a method for deep learning training is disclosed according to an embodiment. In step 405, a code and unit test quality filter computer program may receive raw data for source code from a database and may identify a function in the source code for which a unit test will be generated, and an existing unit test for that function.

In step 410, the transformer computer program may receive the function for unit test, the existing unit test for the function, and optionally, additional source code features such as an Abstract Syntax Tree (“AST”), a docstring, etc. The additional source code features may be related to the function that the unit test is based on or will evaluate.

In step 415, the transformer computer program may generate a generated unit test for the function using the inputs. The generation step may depend on the deep learning model of choice. For example, it may be token-by-token generation and/or character-by-character generation.

In step 420, a loss function may be applied to the generated unit test and the results may be fed back to the transformer computer program. For example, the loss function may be based on a comparison of the generated unit test to the existing test for the function and a unit test quality filter, such as a code and unit test quality filter computer program.

An example of a unit test quality filter is provided in U.S. patent application Ser. No. 17/933,302, the disclosure of which is hereby incorporated, by reference, in its entirety.

In one embodiment, an auxiliary loss function that may be derived from quality and performance metrics may be used. The auxiliary loss function may be independent of the loss function and optional loss terms, such as loss regularization, etc., may be added to the auxiliary loss function. The auxiliary loss function and the loss function may be used to retrain and/or fine tune the deep learning model and may thus affect the generation of the generated unit test.

In one embodiment, the auxiliary loss function may be used when the prediction is not accurate. The auxiliary loss function may be added to the loss function to regularize the loss function (e.g., using loss regularization) and to improve the accuracy of the results.

In embodiments, the data-driven thresholds may be set to determine if the model should stop generation of the generated unit test. One option to determine this is to run the generated unit test through a simulator. At training, the loss term may be used to determine completion.

In step 425, if the threshold is met, the training may be stopped, and the transformer model parameters may be saved.

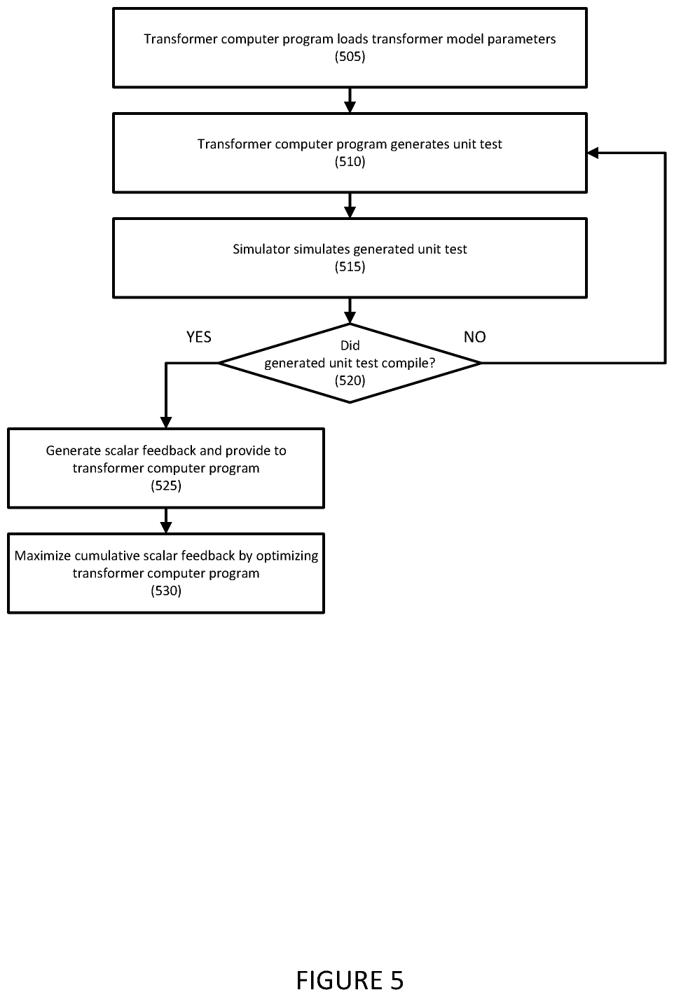

Referring to FIG. 5, a method for reinforcement learning training is disclosed according to an embodiment.

In step 505, a transformer computer program may load transformer model parameters, and in step 510 may generate a unit test.

In step 515, a simulator may simulate the generated unit test. The generated unit test may be refined by simulating the generated unit test using a simulator. The simulator may determine if the unit test compiles.

In step 520, if the generated unit test does not compile, the transformer computer program may re-generate the unit test.

If the generated unit test does compile, in step 525, scalar feedback may be generated, and the scalar feedback is provided to the transformer computer program. For example, the scalar feedback may be a number that evaluates the generated test using the Net Scalar Reward Function. It may also take into account quality and performance metrics.

In step 530, the transformer computer program may refine the generated unit test based on the scalar feedback. For example, the generated unit test may be fine-tuned to maximize the value of the scalar feedback from the Net Scalar Reward Function.

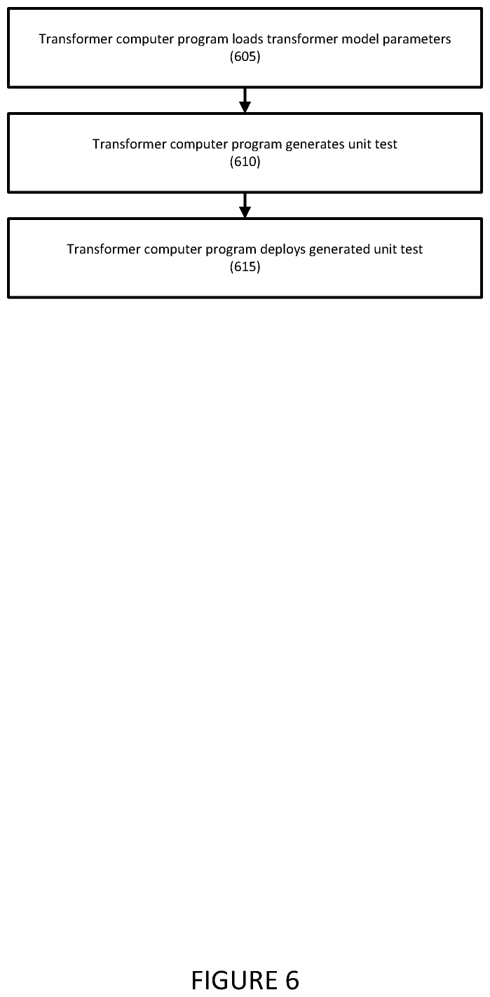

Referring to FIG. 6, a method for generation of a unit test during inference is disclosed according to an embodiment.

In step 605, a transformer computer program may load transformer model parameters, and in step 610 may generate a unit test.

In step 615, the generated unit test may be deployed.

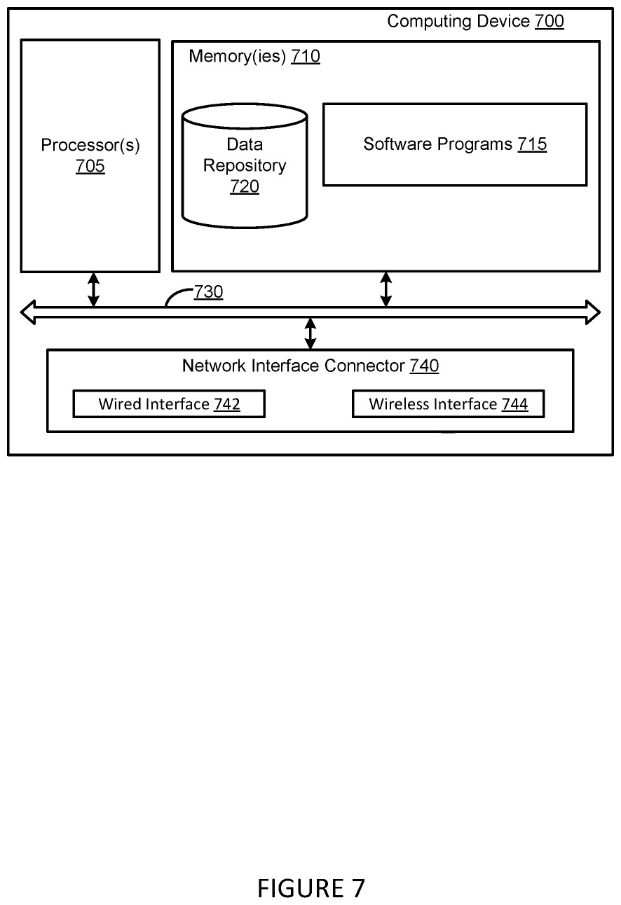

FIG. 7 depicts an exemplary computing system for implementing aspects of the present disclosure. FIG. 7 depicts exemplary computing device 700. Computing device 700 may represent the system components described herein. Computing device 700 may include processor 705 that may be coupled to memory 710. Memory 710 may include volatile memory. Processor 705 may execute computer-executable program code stored in memory 710, such as software programs 715. Software programs 715 may include one or more of the logical steps disclosed herein as a programmatic instruction, which may be executed by processor 705. Memory 710 may also include data repository 720, which may be nonvolatile memory for data persistence. Processor 705 and memory 710 may be coupled by bus 730. Bus 730 may also be coupled to one or more network interface connectors 740, such as wired network interface 742 or wireless network interface 744. Computing device 700 may also have user interface components, such as a screen for displaying graphical user interfaces and receiving input from the user, a mouse, a keyboard and/or other input/output components (not shown).

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may include cloud-based processors.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for unit test generation using reinforcement learning augmented transformer architectures, comprising:
receiving, by a code and unit test quality filter computer program, raw data for source code from a database;
identifying, by the code and unit test quality filter computer program, a function for which a unit test will be generated and an existing unit test for that function;
receiving, by a transformer computer program, the function and the existing unit test;
generating, by the transformer computer program, a generated unit test for the function using the function for the unit test and the existing unit test using a deep learning model;
applying, by the transformer computer program, a loss function to the generated unit test, wherein the loss function is based on a comparison between the generated unit test and the existing unit test and results of the application of the loss function are fed back to the transformer computer program;
simulating, by a simulator computer program, the generated unit test using a simulator;
generating, by a simulator computer program, scalar feedback; and
refining, by the transformer computer program, the generated unit test using the scalar feedback.

2. The method of claim 1, wherein the transformer computer program further receives an abstract syntax tree or a docstring for the source code.

3. The method of claim 1, further comprising:
generating, by the code and unit test quality filter computer program, an auxiliary loss function; and
retraining, by the code and unit test quality filter computer program, the deep learning model using the loss function and the auxiliary loss function.

4. The method of claim 1, wherein the unit test is generated using token-by-token generation and/or character-by-character generation.

5. The method of claim 1, further comprising:
repeating the steps of generating the loss function, simulating the generated unit test, generating scalar feedback, and refining the generated unit test until a data-driven threshold is met.

6. The method of claim 5, wherein the data-driven threshold is based on the loss function.

7. A method for reinforcement learning training, comprising:
loading, by a transformer computer program, model parameters;
generating, by the transformer computer program, a generated unit test using the model parameters;
determining, by a simulator, that the generated unit test compiles;
generating, by the simulator, scalar feedback by simulating the generated unit test; and
refining, by the transformer computer program, the generated unit test based on the scalar feedback.

8. The method of claim 7, wherein the scalar feedback is generated using a net scalar reward function.

9. The method of claim 7, wherein the scalar feedback is based on quality metrics and/or performance metrics.

10. The method of claim 8, wherein the transformer computer program refines the generated unit test to maximize the net scalar reward function.

11. A non-transitory computer readable storage medium, including instructions stored thereon, which when read and executed by one or more computer processors, cause the one or more computer processors to perform steps comprising:
receiving raw data for source code from a database;
identifying a function for which a unit test will be generated and an existing unit test for that function;
receiving the function and the existing unit test;
generating a generated unit test for the function using the function for the unit test and the existing unit test using a deep learning model;
applying a loss function to the generated unit test, wherein the loss function is based on a comparison between the generated unit test and the existing unit test;
simulating the generated unit test using a simulator;
generating scalar feedback; and
refining the generated unit test using the scalar feedback.

12. The non-transitory computer readable storage medium of claim 11, further including instructions stored thereon, which when read and executed by one or more computer processors, cause the one or more computer processors to receive an abstract syntax tree or a docstring for the source code.

13. The non-transitory computer readable storage medium of claim 11, further including instructions stored thereon, which when read and executed by one or more computer processors, cause the one or more computer processors to perform steps comprising:
generating an auxiliary loss function; and
retraining the deep learning model using the loss function and the auxiliary loss function.

14. The non-transitory computer readable storage medium of claim 11, wherein the unit test is generated using token-by-token generation and/or character-by-character generation.

15. The non-transitory computer readable storage medium of claim 11, further instructions stored thereon, which when read and executed by one or more computer processors, cause the one or more computer processors to perform steps comprising:
repeating the steps of generating the loss function, simulating the generated unit test, generating scalar feedback, and refining the generated unit test until a data-driven threshold is met.

16. The non-transitory computer readable storage medium of claim 15, wherein the data-driven threshold is based on the loss function.
